(19) United States
(12) Patent Application Publication
(10) Pub. No.: US 2011/0095006 A1
(43) Pub. Date: Apr. 28, 2011

(54) LASER DICING METHOD AND LASER DICING APPARATUS

(75) Inventor: MAKOTO HAYASHI, Kanagawa (JP)

(73) Assignee: TOSHIBA KIKAI KABUSHIKI KAISHA, CHIYODA-KU (JP)

(21) Appl. No.: 12/911,277

(22) Filed: Oct. 25, 2010

(30) Foreign Application Priority Data
Oct. 26, 2009 (JP) 2009-245573

(51) Int. Cl. B23K 26/00; B23K 26/38

(52) U.S. Cl. 219/121.72; 219/121.67

(57) ABSTRACT

The present invention provides a laser dicing method that optimizes an irradiation pattern of a pulse laser beam to control generation of a crack and has a superior cutting characteristic. The laser dicing method includes loading a work piece on a stage, generating a clock signal, emitting a pulse laser beam synchronized with the clock signal, relatively moving the work piece and the pulse laser beam, and switching irradiation and non-irradiation of the pulse laser beam onto the work piece in the unit of a light pulse by controlling pass and interception of the pulse laser beam in synchronization with the clock signal, thereby forming a crack running up to a work piece surface in the work piece.

### CROSS-REFERENCE TO RELATED APPLICATION

This application is based on and claims priority of Japanese Patent Application (JPA) No. 2009-245573, filed on Oct. 26, 2009, the entire contents of which are incorporated herein by reference.

### FIELD OF THE INVENTION

The present invention relates to a laser. dicing method and a laser dicing apparatus using a pulse laser beam.

### BACKGROUND OF THE INVENTION

A method that uses a pulse laser beam in dicing of a semiconductor substrate is disclosed in Japanese Patent No. 3867107. According to this method, a pulse laser beam causes optical damage to form a crack region inside of a work piece. Then, the work piece is cut on the basis of the crack region. In other words, the crack region behaves as a starting point of cleavage of the work piece.

In the related art, formation of the crack region is controlled using energy and a spot diameter of the pulse laser beam and the relative movement velocity of the pulse laser beam and the work piece as parameters.

However, the conventional method is problematic in that a crack is generated in an unexpected place and the generation of the crack cannot be controlled sufficiently. For this reason, it is difficult to apply the conventional method to dicing of a work piece made of a hard material, such as sapphire substrate, or dicing with small cutting width.

### SUMMARY OF THE INVENTION

The present invention has been made in view of the above circumferences, and it is an object of the present invention to provide a laser dicing method and a laser dicing apparatus that optimize an irradiation pattern of a pulse laser beam to control generation of a crack, thereby having a superior cutting or dicing characteristic.

A laser dicing method according to an aspect of the present invention includes: loading a work piece on a stage; generating a clock signal; emitting a pulse laser beam synchronized with the clock signal; relatively moving the work piece and the pulse laser beam; switching irradiation and non-irradiation of the pulse laser beam onto the work piece in the unit of light pulses by controlling pass and interception of the pulse laser beam in synchronization with the clock signal, thereby forming a crack running up to a substrate surface in the work piece.

In the method according to the above aspect, irradiation and non-irradiation of the pulse laser beam are preferably performed under a predetermined condition defined by the number of light pulses.

In the method according to the above aspect, relative movement of the work piece and the pulse laser beam is preferably achieved by movement of the stage.

In the method according to the above aspect, when the pulse laser beam is irradiated or not irradiated, the stage preferably moves at the constant speed.

In the method according to the above aspect, the irradiation and non-irradiation of the pulse laser beam are preferably carried in synchronization with the position of the stage.

In the method according to the above aspect, the work piece is preferably a sapphire substrate.

A laser dicing apparatus according to an aspect of the present invention includes: a stage that can be loaded with a work piece; a reference clock oscillation circuit that generates a clock signal; a laser oscillator that emits a pulse laser beam; a laser oscillator controller that synchronizes the pulse laser beam with the clock signal; a pulse picker that is provided on an optical path between the laser oscillator and the stage, and switches irradiation and non-irradiation of the pulse laser beam onto the work piece; and a pulse picker controller that controls pass and interception of the pulse laser beam at the pulse picker in the unit of light pulses, in synchronization with the clock signal.

Preferably, the apparatus according to the above aspect includes a processing table unit that stores a processing table where dicing processing data is described with the number of light pulses of the pulse laser beam, and, in the apparatus, a pulse picker controller controls pass and interception of the pulse laser beam in a pulse picker, on the basis of the processing table.

### BRIEF DESCRIPTION OF THE DRAWINGS

FIG. 1 is a schematic constructional view illustrating an example of a laser dicing apparatus that is used in a laser dicing method according to an embodiment of the present invention;

FIG. 2 is a diagram illustrating timing control of the laser dicing method according to the embodiment;

FIG. 3 is a diagram illustrating timing of a modulated pulse laser beam and operation of a pulse picker in the laser dicing method according to the embodiment;

FIG. 4 is a diagram illustrating an irradiation pattern used in the laser dicing method according to the embodiment;

FIG. 5 is a top view illustrating an irradiation pattern that is irradiated onto a sapphire substrate;

FIG. 6 is a cross-sectional view taken along the line A-A of FIG. 5;

FIG. 7 is a diagram illustrating a relationship of stage movement and dicing processing;

FIG. 8 is a diagram illustrating an irradiation pattern according to a first example;

FIGS. 9A to 9C illustrate the results of laser dicing according to the first example;

FIGS. 10A and 10B illustrate the results of laser dicing according to a second example;

FIGS. 11A and 11B illustrate the results of laser dicing according to a third example;

FIGS. 12A to 12C illustrate the results of laser dicing according to a fourth example;

FIGS. 13A and 13B illustrate the results of laser dicing according to a fifth example; and

FIGS. 14A to 14D illustrate the results of laser dicing according to sixth to ninth examples.

### DETAILED DESCRIPTION OF THE INVENTION

Hereinafter, an exemplary embodiment will be described with reference to the drawings.

In a laser dicing method according to the present embodiment, a work piece is loaded on a stage, a clock signal is generated, a pulse laser beam is emitted in synchronization with the clock signal, and the work piece and the pulse laser beam are relatively moved, so that the pulse laser beam is controlled to pass through or to be intercepted in a pulse picker in synchronization with the clock signal. Thus, irradiation and non-irradiation of the pulse laser beam onto the work piece are switched in the unit of light pulses and, as a result, a crack running up to the surface of the work piece is formed.

With this configuration, irradiation and non-irradiation of the pulse laser beam onto the work piece can be executed with high precision, by an optimal distribution. Accordingly, generation of a crack running up to the surface of a work piece can be controlled and the crack region can be stably formed in an optimal shape. As a result, a laser dicing method having a superior cutting characteristic can be provided.

A laser dicing apparatus according to the present embodiment for implementing the laser dicing method includes: a stage that can support or hold a work piece; a reference clock oscillation circuit that generates a clock signal; a laser oscillator that emits a pulse laser beam; a laser oscillator controller that synchronizes the pulse laser beam with the clock signal; a pulse picker that that is provided on an optical path between the laser oscillator and the stage, and switches irradiation and non-irradiation of the pulse laser beam onto the work piece; and a pulse picker controller that controls pass and interception of the pulse laser beam at the pulse picker in the unit of light pulses, in synchronization with the clock signal.

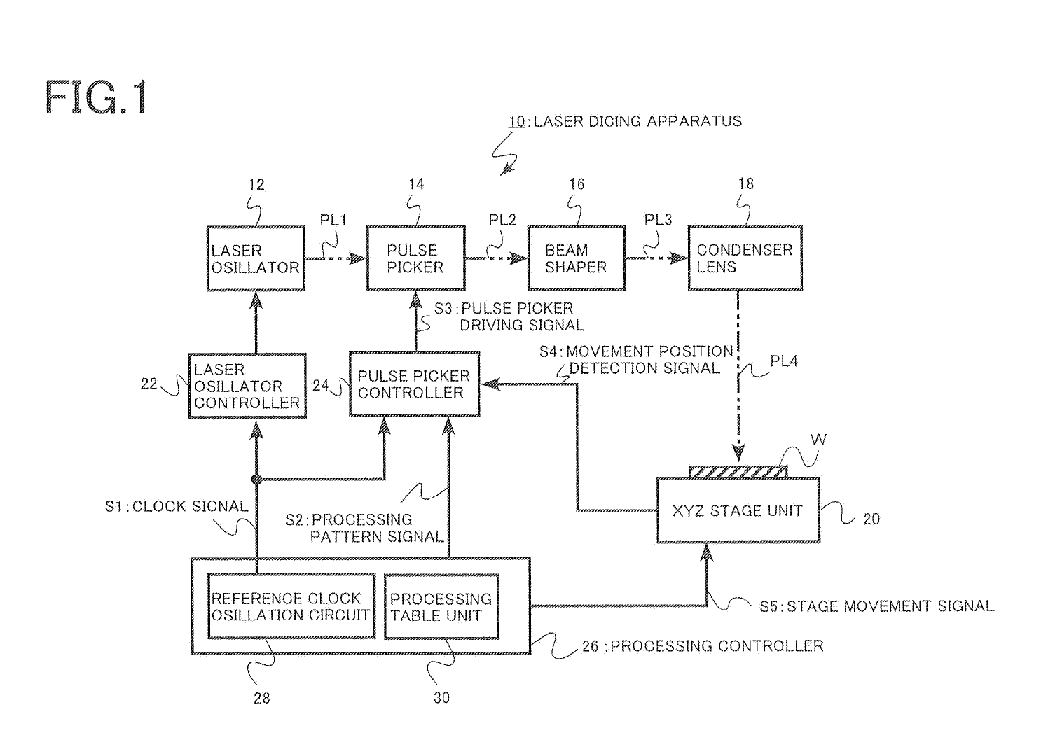

FIG. 1 is a schematic constructional view illustrating an example of a laser dicing apparatus according to the present embodiment. As illustrated in FIG. 1, a laser dicing apparatus 10 according to the present embodiment includes a laser oscillator 12, a pulse picker 14, a beam shaper 16, a condenser lens 18, an XYZ stage unit 20, a laser oscillator controller 22, a pulse picker controller 24, and a processing controller 26 as main components. The processing controller 26 includes a reference clock oscillation circuit 28 generating a desired clock signal S1 and further includes a processing table unit 30.

The laser oscillator 12 is configured to emit a pulse laser beam PL1 with a cycle Tc, which is synchronized with the clock signal S1 generated by the reference clock oscillation circuit 28. The strength of irradiated pulse light shows a Gaussian distribution.

In this case, the wavelength of laser that is emitted from the laser oscillator 12 should have a light transmitting property with respect to the work piece. The laser that may be used include Nd: YAG laser, Nd:YVO₄ laser, and Nd:YLF laser. For example, when the work piece is a sapphire substrate, it is preferable to use the Nd:YVO₄ laser with a wavelength of 532 nm.

The pulse picker 14 is provided on an optical path between the laser oscillator 12 and the condenser lens 18. The pulse picker 14 is configured to switch pass and interception (ON/OFF) of the pulse laser beam PL1 in synchronization with the clock signal S1 to switch irradiation and non-irradiation of the pulse laser beam PL1 onto the work piece in the unit of light pulses. As such, by the operation of the pulse picker 14, turn-on and turn-off of the pulse laser beam PL1 is controlled to process the work piece and, as a result, the pulse laser beam becomes a modulated pulse laser beam PL2.

The pulse picker 14 preferably comprises an acousto-optical modulator (AOM). Alternatively, the pulse picker 14 may comprise an electro-optical modulator (EOM) of a Raman diffraction type.

The beam shaper 16 shapes the incident pulse laser beam PL2 into a desired shape to generate a pulse laser beam PL3. For example, the beam shaper 16 may be a beam expander that expands the beam diameter with the constant magnification. The beam shaper 16 may include an optical element, such as a homogenizer which causes the light strength in a beam section to be distributed uniformly. The beam shaper 16 may also include, for example, an optical element that shapes a beam section into a circular shape or an optical element that converts a beam into circularly polarized light.

The condenser lens 18 is configured to condense the pulse laser beam PL3 shaped by the beam shaper 16 and irradiate a pulse laser beam PL4 onto a work piece W loaded and held on the XYZ stage unit 20, for example, a work piece W may be a sapphire substrate with LEDs formed on the bottom surface.

The XYZ stage unit 20 includes an XYZ stage (hereinafter, also simply referred to as stage) that can be loaded with the work piece W and freely move in an XYZ direction, a driving mechanism unit, and a position sensor that has, for example, a laser interferometer to measure a position of the stage. In this case, the XYZ stage operates with precision as high as a range of submicron with respect to positioning accuracy and movement error.

The processing controller 26 controls the entire processing performed by the laser dicing apparatus 10. The reference clock oscillation circuit 28 generates a desired clock signal S1. The processing table unit 30 stores a processing table where dicing processing data is described with the number of light pulses of the pulse laser beam.

Next, the laser dicing method using the laser dicing apparatus 10 will be described using FIGS. 1 to 7.

First, the work piece W, for example, the sapphire substrate is loaded on the XYZ stage unit 20. The sapphire substrate is a wafer having a GaN layer, which is epitaxially grown on the bottom thereof and is provided with a plurality of LEDs formed in the form of a pattern. In addition, positioning of the wafer with respect to the XYZ stage is performed on the basis of a notch or an orientation flat of the wafer.

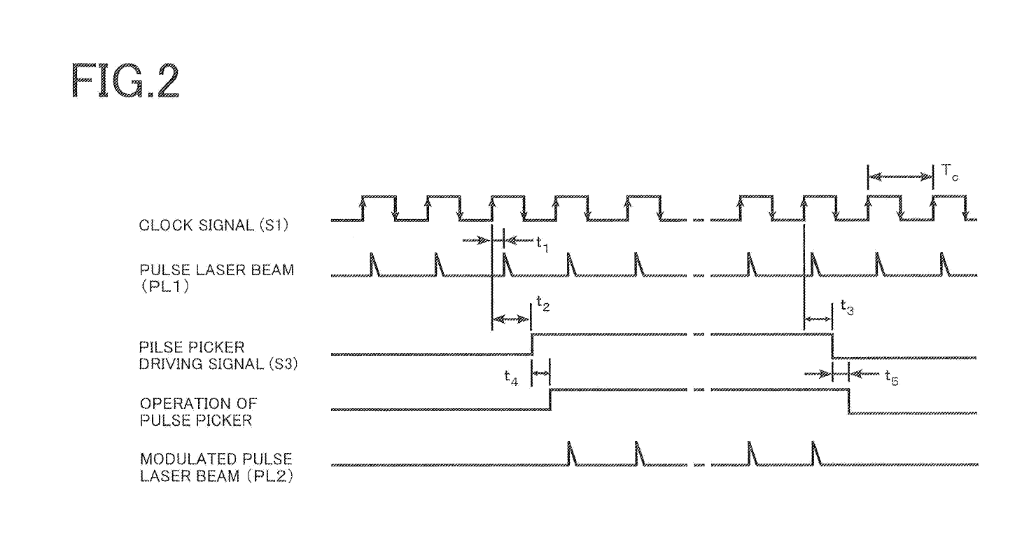

FIG. 2 is a diagram illustrating timing control of the laser dicing method according to the present embodiment. In the reference clock oscillation circuit 28 in the processing controller 26, the clock signal Si with a cycle Tc is generated. The laser oscillator controller 22 controls the laser oscillator 12 so that the laser oscillator 12 emits the pulse laser beam PL1 with the cycle Tc synchronized with the clock signal S1. For this instance, there is likely to be a delay time t₁ between a rising edge of the clock signal S1 and a rising edge of the pulse laser beam.

The laser beam which is used has the wavelength being capable of transmitting through the work piece. In this case, it is preferable to use a laser beam having energy hv of a photon that is larger than an absorption band gap Eg of a material of the work piece. If the energy hv is extraordinarily larger than the band gap Eg, the laser beam is absorbed. This is called multiple photon absorption. If the pulse width of the laser beam is extremely decreased and the multiple photon absorption is caused in the work piece, permanent structural change, such as ion valance change, crystallization, amorphousness, polarization of orientation, or generation of minute cracks, are induced without changing energy of the multiple photon absorption to heat energy, and a refractive index change region (color center) is formed.

If the wavelength with the light transmitting property is used with respect to the material of the work piece, the laser beam can be guided and condensed in the vicinity of a focus of an inner portion of the substrate. Accordingly, the refractive index change region can be locally processed. Hereinafter, this refractive index change region is called a modified region.

The pulse picker controller 24 refers to a processing pattern signal S2 that is output from the processing controller 26 and generates a pulse picker driving signal S3 that is synchronized with the clock signal S1. The processing pattern signal S2 is stored in the processing table unit 30 and is generated on the basis of the processing table where information of the irradiation pattern is described with the number of light pulses in a light pulse unit. The pulse picker 14 switches pass and interception (ON/OFF) of the pulse laser beam PL1 in synchronization with the clock signal S1, on the basis of the pulse picker driving signal S3.

By the operation of the pulse picker 19, the modulated pulse laser beam PL2 is generated. Between a rising edge of the clock signal S1 and a rising edge and a falling edge of the pulse laser beam, there are delay times t₂ and t₃, respectively. Between the rising edge and the falling edge of the pulse laser beam and the operation of the pulse picker, there are delay times t₄ and t₅, respectively.

At the time of processing the work piece, timing of generating the pulse picker driving signal S3 or the like and timing of relatively moving the work piece and the pulse laser beam are determined by taking the delay times t₁ to t₅ into account.

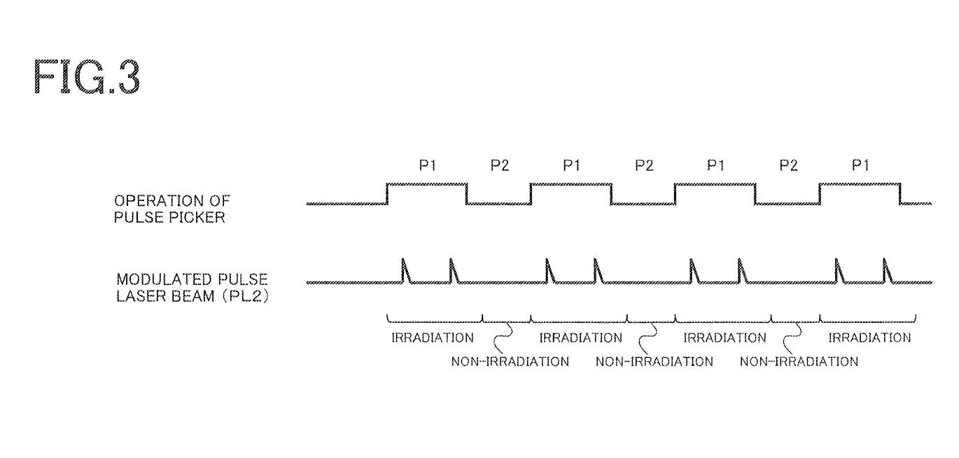

FIG. 3 is a diagram illustrating timing of the modulated pulse laser beam PL2 and the pulse picker operation of the laser dicing method according to the present embodiment. The operation of the pulse picker is switched in a light pulse unit in synchronization with the clock signal S1. As such, if oscillation of the pulse laser beam and the operation of the pulse picker are synchronized with the same clock signal S1, an irradiation pattern in the unit of light pulses can be obtained.

Specifically, irradiation and non-irradiation of the pulse laser beam are performed under predetermined conditions defined by the number of light pulses. That is, the operation of the pulse picker is executed on the basis of an irradiation light pulse number (P1) and a non-irradiation light pulse number (P2), and irradiation and non-irradiation onto the work piece are switched. A P1 value or a P2 value that defines an irradiation pattern of the pulse laser beam is set as irradiation region register setting or non-irradiation region register setting in the processing table. The P1 value and the P2 value are set so as to achieve predetermined conditions to optimize crack formation at the time of dicing, depending on the condition of the laser beam and a material of the work piece.

The modulated pulse laser beam PL2 is converted into. the pulse laser beam PL3 that is shaped into a desired shape by the beam shaper 16. The shaped pulse laser beam PL3 is condensed by the condenser lens 18 and becomes a pulse laser beam PL4 with a desired beam diameter. The pulse laser beam PL4 is irradiated onto the wafer that is the work piece.

When the wafer is to be diced in an X-axis direction and a Y-axis direction, at first, the XYZ stage is moved in the X-axis direction at a constant speed to be scanned with the pulse laser beam PL4. After the desired dicing of the X-axis direction ends, the XYZ stage is moved in the Y-axis direction at a constant speed to be scanned with the pulse laser beam PL4. Thereby, the dicing of the Y-axis direction is performed.

In connection with a Z-axis direction (height direction), the focal position of the condenser lens is adjusted to be at the predetermined depth in the wafer. The predetermined depth is set such that the crack is formed in a desired shape at the time of dicing.

At this time, if a refractive index of the work piece is set as n, the processing position from a surface of the work piece is set as L, and the. distance of the Z-axis movement is set as Lz, Lz=L/n is satisfied. That is, in the case where the surface of the work piece is processed at a position having a depth “L” from the substrate surface when the condenser position based on the condenser lens is set as the Z-axis initial position, the Z axis may be moved by “Lz.”

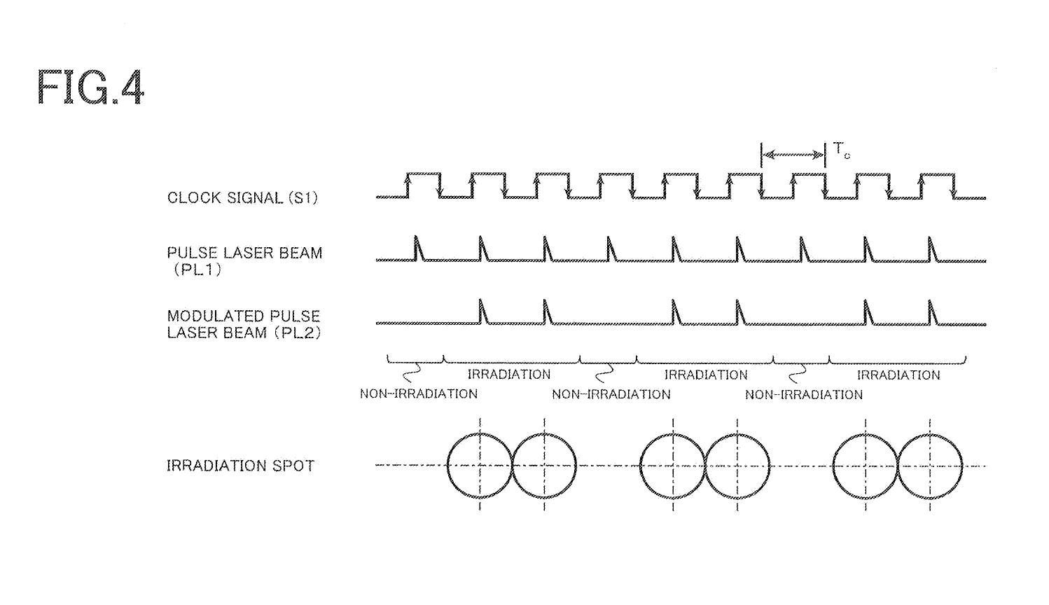

FIG. 4 is a diagram illustrating an irradiation pattern used in the laser dicing method according to the present embodiment. As shown in FIG. 4, the pulse laser beam PL1 is generated in synchronization with the clock signal S1. As pass and interception of the pulse laser beam are controlled in synchronization with the clock signal S1, the modulated pulse laser beam PL2 is generated.

By moving the stage in a horizontal direction (X-axis direction or Y-axis direction), an irradiation light pulse of the modulated pulse laser beam PL2 is formed as an irradiation spot on the wafer. As such, by generating the modulated pulse laser beam PL2, the irradiation spot on the wafer is controlled pin the unit of light pulses and is intermittently irradiated. In the case of FIG. 4, conditions where an irradiation light pulse number (P1) equals to 2, a non-irradiation light pulse number (P2) equals to 1, and irradiation and non-irradiation of an irradiation light pulse (Gaussian light) are repeated at the pitch of the spot diameter are set.

In this case, if processing is executed under conditions where the beam spot diameter is denoted by D (μm) and a repetition frequency is denoted by F (KHz), the movement speed V (m/sec) of the stage to repeat irradiation and non-irradiation of the irradiation light pulse at the pitch of the spot diameter is represented by:

V=D×10⁻⁶×F×10³.

For example, if processing is performed under processing conditions where the beam spot diameter D equals to 2 μm and a repetition frequency F equals to 50 KHz, the movement speed of the stage V equals to 100 mm/sec.

If power of the irradiation light is set as P (watt), a light pulse with irradiation pulse energy per pulse (P/F) is irradiated onto the wafer.

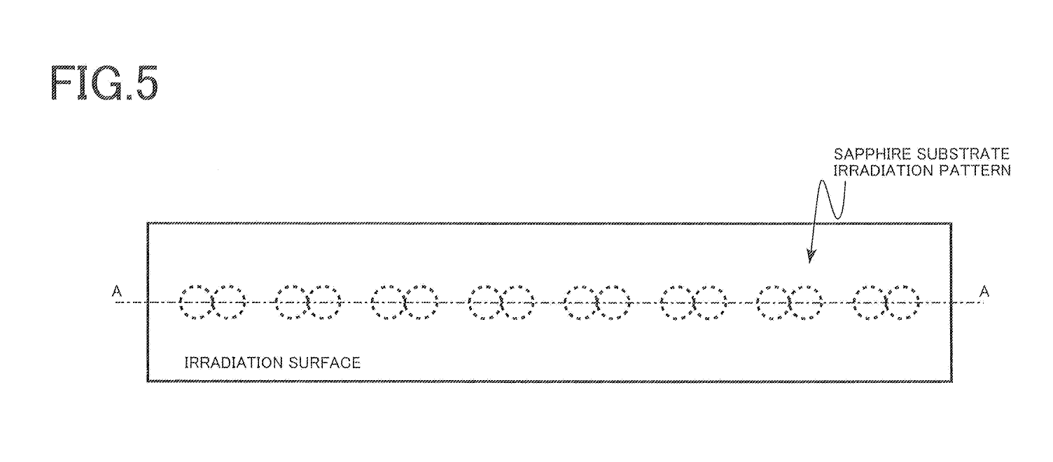

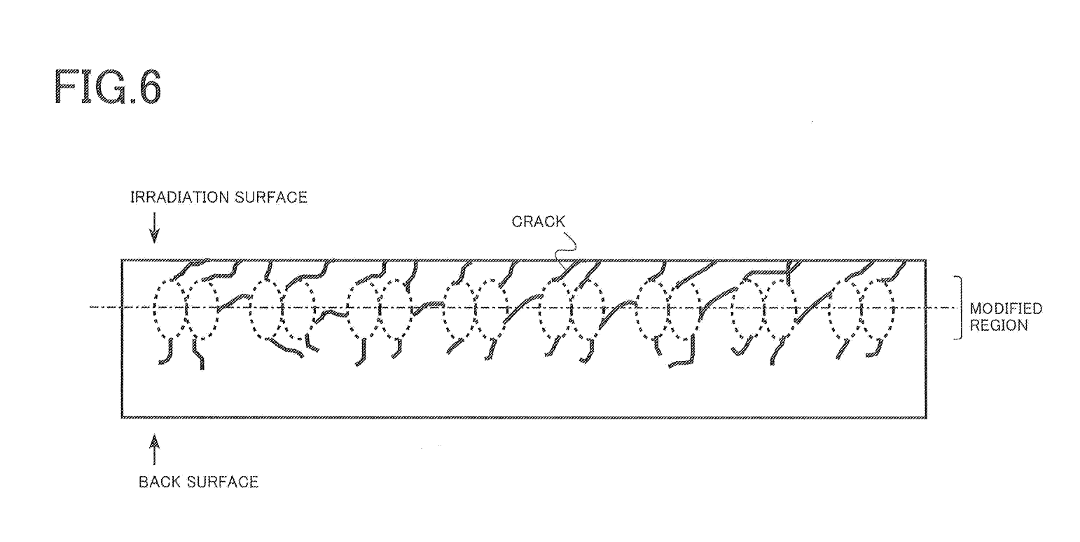

FIG. 5 is a top view illustrating an irradiation pattern of light that is irradiated onto a sapphire substrate. As viewed from an upper side of the irradiation surface, the irradiation light pulse number (P1) equals to 2; the non-irradiation light pulse number (P2) equals to 1; and irradiation spots are formed at the pitch of the irradiation spot diameter. FIG. 6 is a cross-sectional view taken along the line A-A of FIG. 5. As shown in FIG. 6, a modified region is formed in the sapphire substrate. A crack that runs from the modified region up to the substrate surface along a scanning line of a light pulse is formed. Also, between regions corresponding to the irradiation spots of the modified region, a crack is generated in a horizontal direction.

As such, due to the crack running up to the substrate surface, cutting of the substrate to be subsequently performed is facilitated. This reduces a dicing cost. After formation of the crack, the substrate is eventually cut, for example, into individual LED chips naturally or by with application of the artificial force. The crack region behaves as a starting point of cutting or cleavage of the substrate.

As in the related art, in the method in which the pulse laser beam is continuously irradiated onto the substrate, even if optimization in the movement speed of the stage, a numerical aperture of the condenser lens, and the power of the irradiation light is made, it is difficult to control the crack running up to the substrate surface to be formed into a desired shape. As in the present embodiment, a laser dicing method in which irradiation and non-irradiation of the pulse laser beam are intermittently switched in the unit of light pulses, an irradiation pattern is optimized, thereby generation of the crack running up to the substrate surface is controlled, and a superior cutting characteristic is realized.

That is, a crack with the small width that is linearly formed along a scanning line of laser can be formed on the substrate surface. This minimizes an influence of the crack on a device, such as LED, formed on the substrate at the time of dicing. Since a linear crack can be formed, it is possible to reduce the width of the region where the crack is formed on the substrate surface. For this reason, the dicing width in designing can be reduced. Accordingly, the number of chips, i.e. devices that can be formed on the same substrate or the wafer can be increased, and a manufacturing cost of the devices can be reduced.

According to the laser dicing apparatus in the embodiment, irradiation and non-irradiation of the pulse laser beam can be arbitrarily set in the unit of light pulses. Accordingly, if irradiation and non-irradiation of the pulse laser beam are switched in the unit of light pulses and an irradiation pattern is optimized, generation of the crack can be controlled and laser dicing having a superior cutting characteristic can be realized.

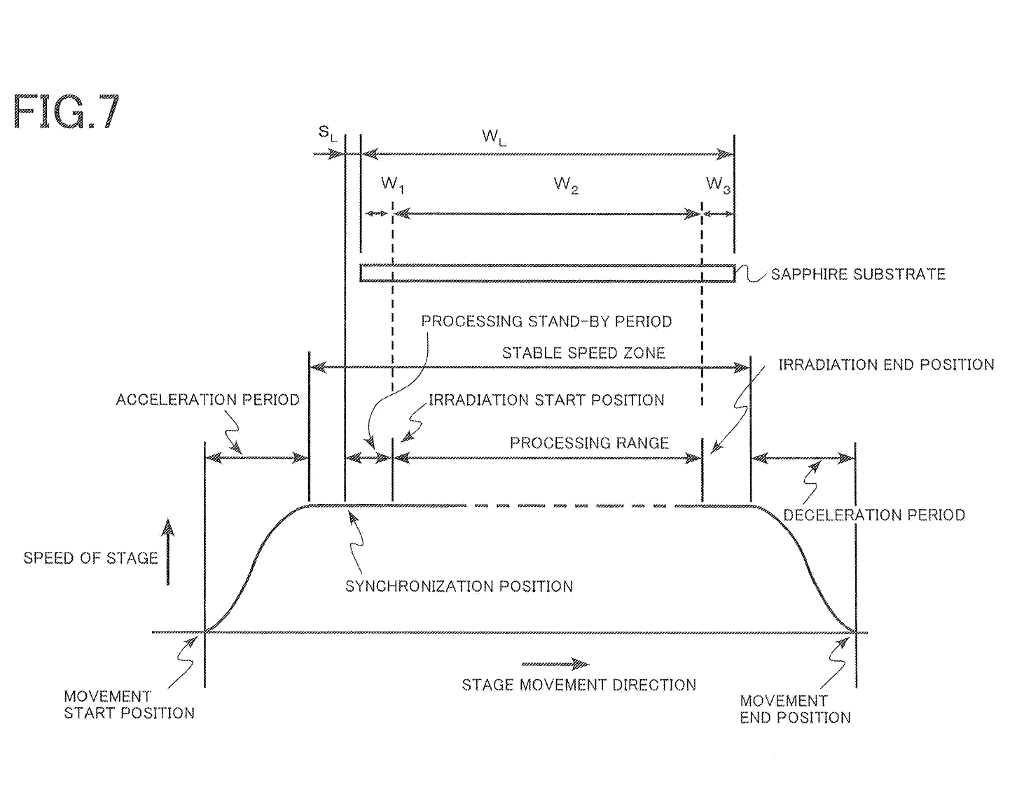

FIG. 7 is a diagram illustrating a relationship between stage movement and dicing processing. In the XYZ stage, position sensors that detect the positions in the X-axis direction and the Y-axis direction are provided. For example, after movement of the stage in the X-axis direction or the Y-axis direction starts, the position where the stage speed falls in a speed stable zone is set in advance as the synchronization position. Accordingly, when the position sensor detects the synchronization position, the operation of the pulse picker operation is permitted following, for example, transmission of a movement position detection signal S4 (refer to FIG. 1) to the pulse picker controller 24, and the pulse picker comes to operate by the pulse picker driving signal S3.

As such, S_{L} denoting distance from the synchronization position to the substrate, W_{L} denoting processing length, W₁ denoting distance from a substrate end to the irradiation start position, W₂ denoting processing range, and W₃ denoting distance from the irradiation end position to the substrate end are managed.

In this way, the stage position and the operation start position of the pulse picker are synchronized with each other. That is, irradiation and non-irradiation of the pulse laser beam and the position of the stage are synchronized with each other. For this reason, when the pulse laser beam is irradiated or not irradiated, it is ensured that the stage moves at a constant speed (falls in the speed stable zone). Accordingly, regularity of the irradiation spot position is secured and a crack is stably formed.

For example, it is preferable to synchronize the movement of the stage with the clock signal to further improve precision of the irradiation spot position. This can be realized by synchronizing a stage movement signal S5 (refer to FIG. 1) transmitted from the processing controller 26 to the XYZ stage unit 20 with the clock signal S1.

The exemplary embodiment of the present invention has been described with reference to the specific examples. However, the present invention is not limited to the specific examples. In the embodiment, some portions of the laser dicing method and some portions of the laser dicing apparatus that are not directly needed to explain the present invention are not described. However, needed elements of the laser dicing method and the laser dicing apparatus may be appropriately selected and used.

All laser dicing methods and laser dicing apparatuses that include the elements of the present invention and can be appropriately designed and modified by those who are skilled in the art are within the scope of the present invention. The scope of the present invention is defined by a scope of the appended claims and equivalents thereof.

For example, in the embodiment, the sapphire substrate where LEDs are formed is exemplified as the work piece. The present invention is useful for the substrate, such as the sapphire substrate, which is hard and is difficult to be cut. However, the work piece may be a semiconductor material substrate, such as a silicon carbide (SiC) substrate, a piezoelectric material substrate, and a glass substrate.

In the embodiment, the case where relative movement of the work piece and the pulse laser beam is achieved by moving the stage is described. However, the present invention may involve a method and apparatus in which the relative movement of the work piece and the pulse laser beam is achieved by, for example, scanning with a pulse laser beam using a laser beam scanner.

In the embodiment, the case where the irradiation light pulse number (P1) equals to 2 and the non-irradiation light pulse number (P2) equals to 1 is described. The values of P1 and P2 may be arbitrary values for achieving an optimal condition. In the embodiment, the case where irradiation and non-irradiation of the irradiation light pulse are repeated at the pitch of the spot diameter is described. However, the optimal condition can be found out by changing the pulse frequency or the movement speed of the stage and changing the pitch of the irradiation and non-irradiation. For example, the pitch of the irradiation and non-irradiation may be set to 1/n or n times of the spot diameter.

In connection with the dicing processing patterns, for example, a plurality of irradiation region registers and a plurality of non-irradiation region registers may be provided, or irradiation region register values and non-irradiation region register values may be changed to desired values at desired timing in real time to accommodate various dicing processing patterns.

The apparatus that includes the processing table unit storing the processing table where the dicing processing data is described with the number of light pulses of the pulse laser beam is exemplified as the laser dicing apparatus. However, any apparatus may be used, as long as the apparatus has the configuration in which pass and interception of the pulse laser beam in the pulse picker in a light pulse unit can be controlled, even though the processing table unit is not included.

### EXAMPLES

Hereinafter, examples of the present invention will be described.

### First Example

The laser dicing is performed under the following conditions, using the method described in the embodiment.

Work piece: sapphire substrate

Laser light source: Nd:YVO₄ laser

Wavelength: 532 nm

Irradiation light pulse number (P1): 1

Non-irradiation light pulse number (P2): 2

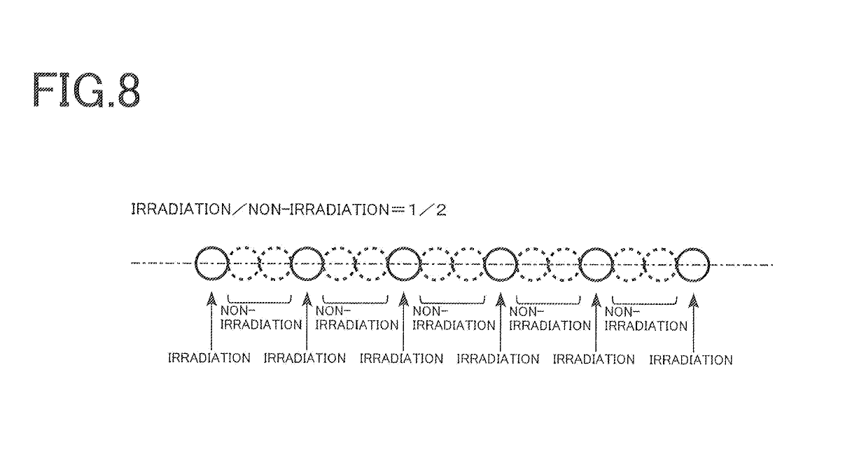

FIG. 8 is a diagram illustrating an irradiation pattern according to a first example. As shown in FIG. 8, after the light pulse is irradiated once, the light is not irradiated by two pulses in terms of the unit of light pulses. Hereinafter, these conditions are described in a format of “irradiation/non-irradiation=½”. The pitch of the irradiation and non-irradiation are equal to the spot diameter.

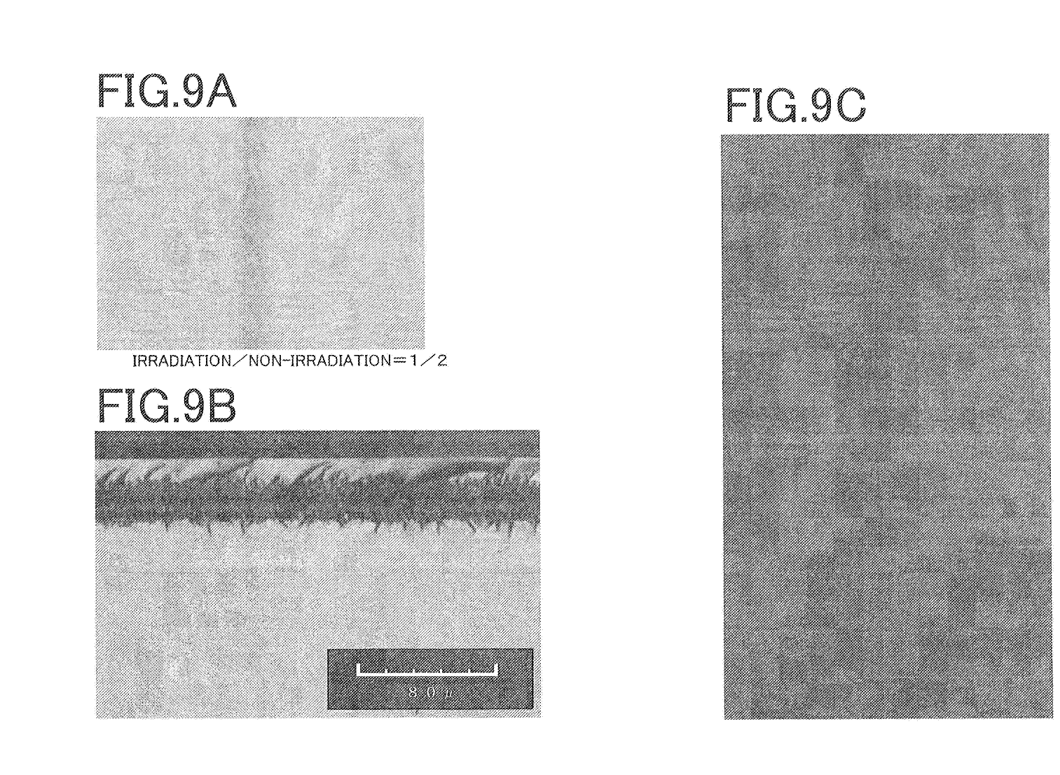

The results of the laser dicing of the above format: are illustrated in FIGS. 9A to 9C. FIG. 9A illustrates a photograph of the top surface of the substrate, FIG. 9B illustrates a photograph of the top surface of the substrate, the photograph having a magnification lower than that of FIG. 9A, and FIG. 9C illustrates a photograph of a section taken along a dicing direction of the substrate.

### Second Example

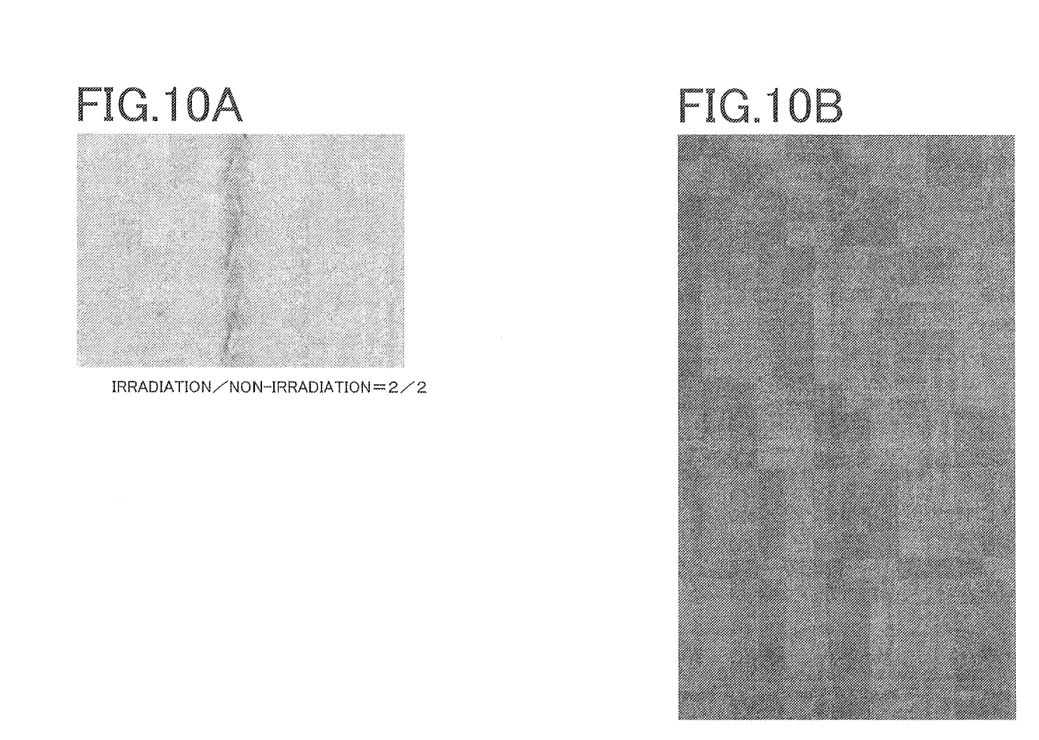

The laser dicing is performed using the same method as that of the first example, except for irradiation/non-irradiation= 2/2. The results of the laser dicing having this format are illustrated in FIGS. 10A and 10B. FIG. 10A illustrates a photograph of the top surface of the substrate and FIG. 10B illustrates a photograph of the top surface of the substrate, the photograph having a magnification lower than that of FIG. 10A.

### Third Example

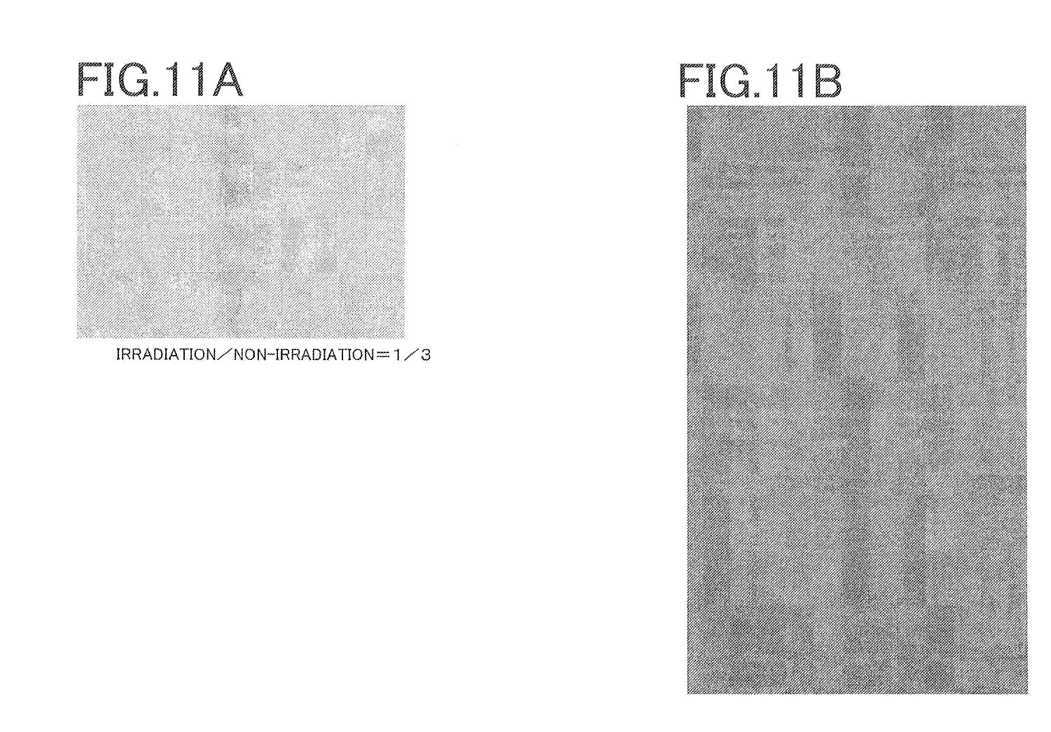

The laser dicing is performed using the same method as that of the first example, except for irradiation/non-irradiation=⅓. The results of the laser dicing of this format are illustrated in FIGS. 11A and 11B. FIG. 11A illustrates a photograph of the top surface of the substrate and FIG. 11B illustrates a photograph having a magnification lower than that of FIG. 11A.

### Fourth Example

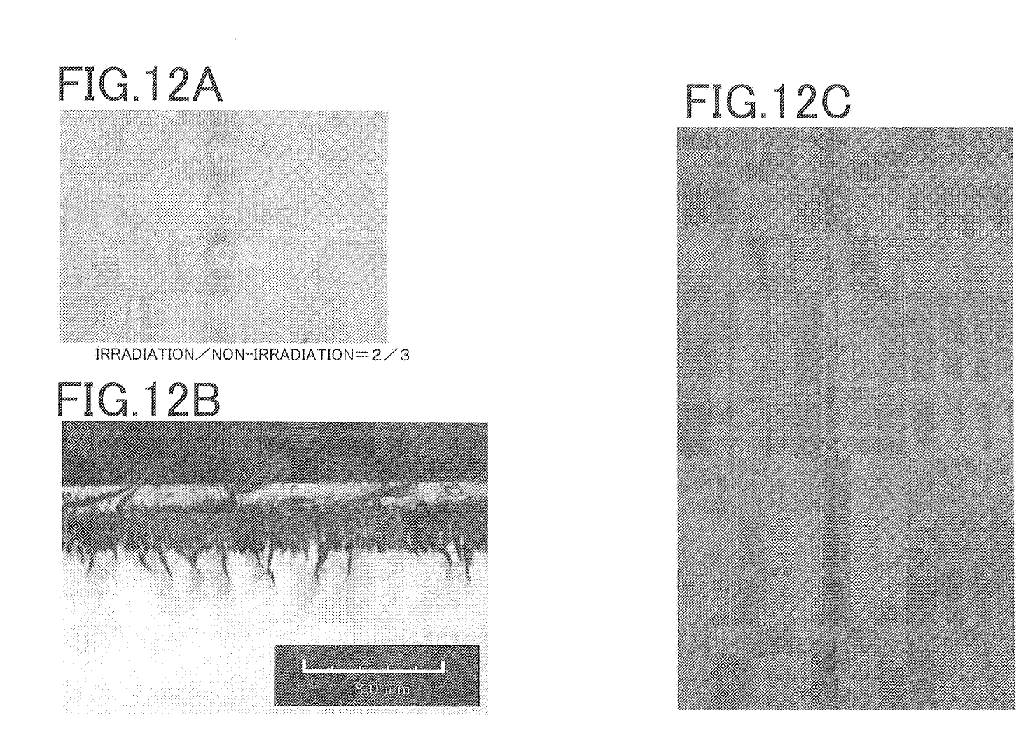

The laser dicing is performed using the same method as that of the first example, except for irradiation/non-irradiation=⅔. The results of the laser dicing of this format are illustrated in FIGS. 12A to 12C. FIG. 12A illustrates a photograph of the top surface of the substrate and FIG. 12B illustrates a photograph having a magnification lower than that of FIG. 12A.

### Fifth Example

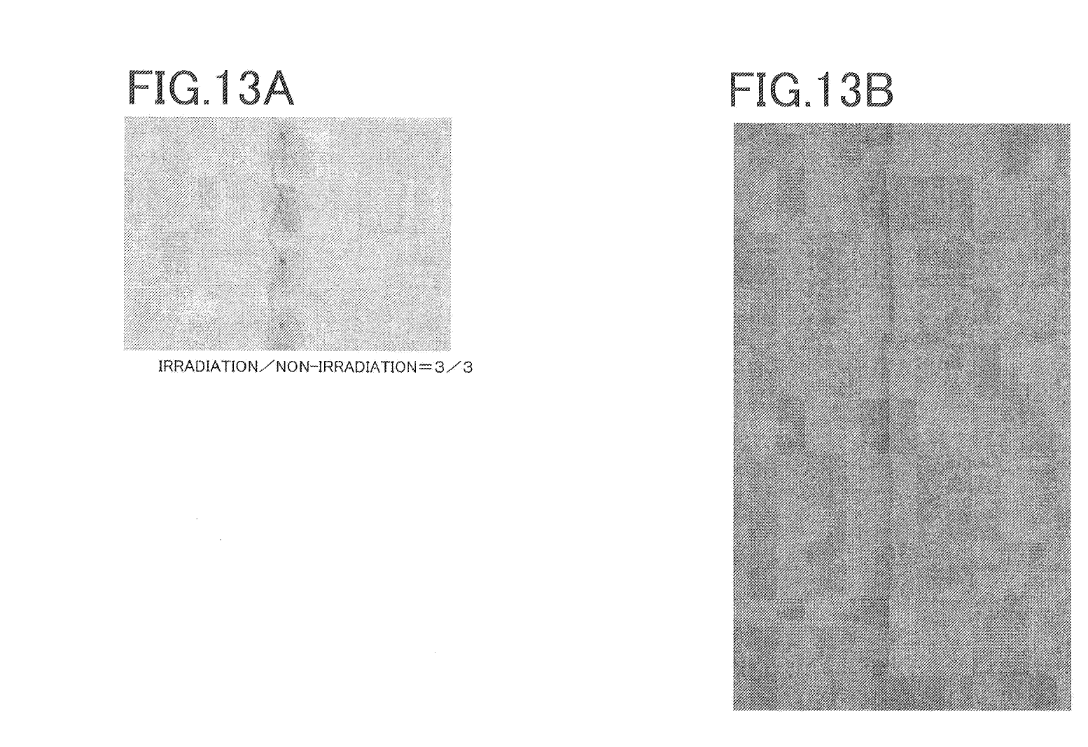

The laser dicing is performed using the same method as that of the first example, except for irradiation/non-irradiation= 3/3. The results of the laser dicing of this format are illustrated in FIGS. 13A and 13B. FIG. 13A illustrates a photograph of the top surface of the substrate and FIG. 13B illustrates a photograph having a magnification lower than that of FIG. 13A.

### Sixth to Ninth Examples

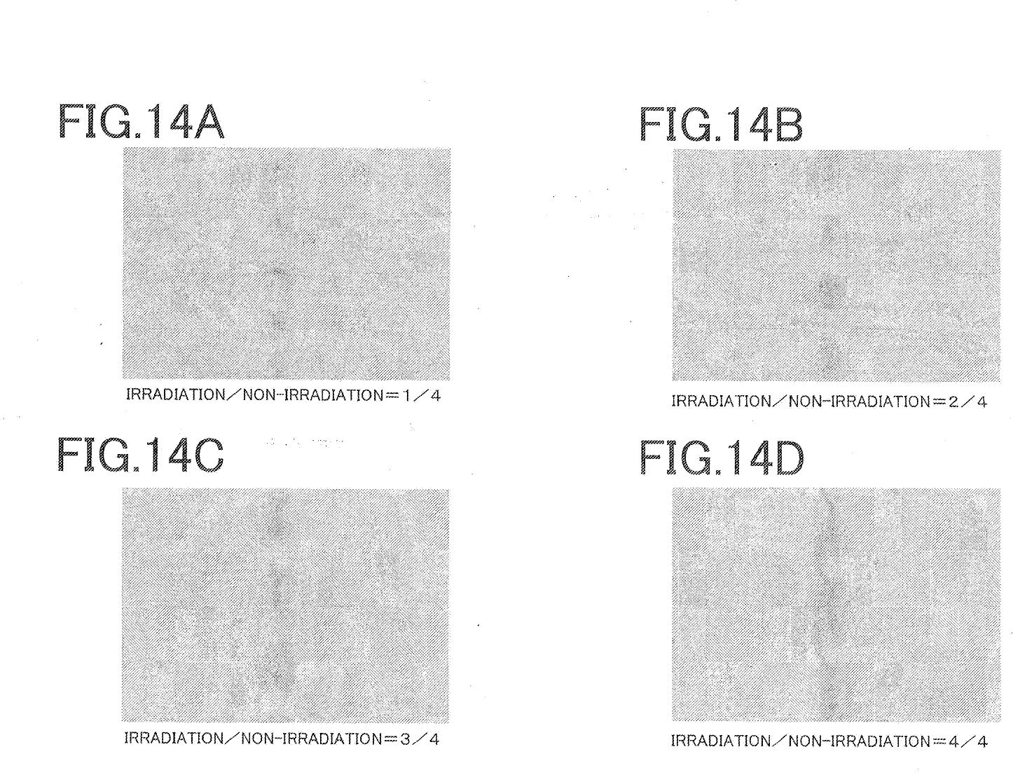

In the sixth to ninth examples, the laser dicing is performed using the same method as that of the first example, except for irradiation/non-irradiation=¼, 2/4, ¾, and 4/4, respectively. The results of the laser dicing are illustrated in FIGS. 14A to 14D. FIG. 14A illustrates a photograph of the top surface of a substrate according to the sixth example, FIG. 14B illustrates a photograph of the top surface of a substrate according to the seventh example, FIG. 14C illustrates a photograph of the top surface of a substrate according to the eighth example, and FIG. 14D illustrates a photograph of the top surface of a substrate according to the ninth example.

In particular, as can be seen from the photographs of sections of FIGS. 9C and 12C, a crack that runs a modified region in the substrate up to the substrate surface is formed. As can be seen from the photographs of FIGS. 9A and 12A, a crack which has a relatively small width and is relatively linear can be formed on the top surface of the substrate, under the condition of irradiation/non-irradiation=½ of the first example and the condition of irradiation/non-irradiation=⅔ of the fourth example. Meanwhile, as can be seen from the photographs of FIGS. 10B and 13B, a crack with a relatively large number of curves can be formed on the top surface of the substrate, under the condition of irradiation/non-irradiation= 2/2 of the second example and the condition of irradiation/non-irradiation= 3/3 of the fifth example.

As described above, it is confirmed that generation of the crack can be controlled by optimizing the irradiation pattern and a superior cutting characteristic can be obtained, when the laser dicing is performed by switching irradiation and non-irradiation of the pulse laser beam in the unit of light pulses.

What is claimed is:

1. A laser dicing method, comprising:
loading a work piece on a stage;
generating a clock signal;
emitting a pulse laser beam synchronized with the clock signal;
relatively moving the work piece and the pulse laser beam; and
switching irradiation and non-irradiation of the pulse laser beam onto the work piece in the unit of light pulses, by controlling pass and interception of the pulse laser beam in synchronization with the clock signal, thereby forming a crack running up to a work piece surface in the work piece.

2. The laser dicing method according to claim 1,
wherein the irradiation and non-irradiation of the pulse laser beam are performed on the basis of a predetermined condition defined by the number of light pulses.

3. The laser dicing method according to claim 1,
wherein the relative movement of the work piece and the pulse laser beam is caused by moving the stage.

4. The laser dicing method according to claim 3,
wherein, when the pulse laser beam is irradiated or not irradiated, the stage moves at a constant speed.

5. The laser dicing method according to claim 3,
wherein the irradiation and non-irradiation of the pulse laser beam are synchronized with a position of the stage.

6. The laser dicing method according to claim 1,
wherein the work piece is a sapphire substrate.

7. A laser dicing apparatus, comprising:
a stage supports a work piece;
a reference clock oscillation circuit generates a clock signal;
a laser oscillator emits a pulse laser beam;
a laser oscillator controller configured to synchronize the pulse laser beam with the clock signal;
a pulse picker provided on an optical path between the laser oscillator and the stage and switches irradiation and non-irradiation of the pulse laser beam onto the work piece; and
a pulse picker controller configured to control pass and interception of the pulse laser beam at the pulse picker in the unit of light pulses, in synchronization with the clock signal.

8. The laser dicing apparatus according to claim 7, further comprising:
a processing table unit stores a processing table, dicing processing data is described in the processing table with the number of light pulses of the pulse laser beam,
wherein the pulse picker controller configured to control the pass and interception of the pulse laser beam at the pulse picker, on the basis of the processing table.
